(19) United States
(12) Patent Application Publication
(10) Pub. No.: US 2008/0284793 A1
(43) Pub. Date: Nov. 20, 2008

(54) Hue and saturation control module

(76) Inventor: Wayne D. Young, Milpitas, CA (US)

Correspondence Address: PATTERSON & SHERIDAN, L.L.P., 3040 POST OAK BOULEVARD, SUITE 1500, HOUSTON, TX, 77056, US

(21) Appl. No.: 10/837,473

(22) Filed: Apr. 30, 2004

Related U.S. Application Data
(63) Continuation-in-part of application No. 10/825,259, filed on Apr. 15, 2004, now Pat. No. 7,050,065.

(51) Int. Cl. G09G 5/02

(52) U.S. Cl. 345/604

(57) ABSTRACT

A graphics processing graphics processing apparatus, which includes an RGB color space to a luminance color, blue color difference and red color difference (YCbCr) color space converter module configured to convert one or more pixel data from the RGB color space to the YCbCr color space using a set of approximated color space coefficients. The graphics processing apparatus further includes a hue and saturation control module coupled to the RGB to YCbCr color space converter module. The hue and saturation control module is configured to modify the hue and saturation of the pixel data in the YCbCr color space. The graphics processing apparatus further includes a YCbCr to RGB color space converter module configured to convert the pixel data from the YCbCr color space to the RGB color space.

### CROSS-REFERENCE TO RELATED APPLICATIONS

This application is a continuation-in-part of co-pending U.S. patent application Ser. No. 10/825,259, Attorney Docket No. NVDA/P000715, entitled MINIMALIST COLOR SPACE CONVERTERS FOR OPTIMIZING IMAGE PROCESSING OPERATIONS by W. Young, filed Apr. 15, 2004, which is incorporated herein by reference.

### BACKGROUND OF THE INVENTION

1. Field of the Invention

Embodiments of the present invention generally relate to a method and apparatus for modifying hue and saturation values of pixel data.

2. Description of the Related Art

The RGB color space is a digital format widely used in computer graphics and imaging. Red, green and blue are the primary additive colors. Components of these primary colors can be combined to form any desired color. The RGB color space is the most prevalent choice for computer graphics frame buffers (the memory used to hold images for display) because computer monitors use red, green and blue phosphors to create the desired color. Consequently, using the RGB color space simplifies the architecture and design of the system.

When modifying the images on a display, RGB is often not the optimal image representation to create such modifications. In particular, hue and saturation are values which can be modified to vary how a resulting image looks on the display. It is desirable to make such modifications in terms of hue and saturation as they represent how such changes are visually perceived. Varying the hue will cause a color to change to a variant of a “base” color (e.g. red, green or blue). Varying the saturation will cause the colors to appear more “pure” (increased saturation) or more “washed out” (decreased saturation). It is known that modifying hue and saturation values are better performed in another color space, such as the YCbCr color space. Accordingly, a color space conversion may need to be performed to convert the pixel data from the RGB color space to another color space, such as the YCbCr color space.

ITU-RBT.601 establishes the following formulas for converting from the RGB color space to the YCbCr color space:

Y=0.299R+0.587G+0.114B (1)

Cb=0.564(B−Y) (2)

Cr=0.713(R−Y) (3)

Color space conversion is often implemented by employing multipliers or look-up tables to achieve the multiplication operations, and by combining the resultant component products to complete the conversion. The multiplication operations dominate the operating efficiency and the hardware complexity of a color space converting apparatus. Therefore, the number of multiplication operations is crucial. A 3-by-3 multiplication is typically used for converting between any two color spaces of three color components. Although such a multiplication offers flexibility, it is relatively expensive to implement.

To perform the RGB to YCbCr color space conversion of equations (1) to (3), a conventional color space converter needs to first perform three multiplication operations to obtain the Y color signal, and then derive the (B−Y) and (R−Y) color difference signals before performing two more multiplication operations to obtain the Cb and Cr color signals, respectively. Although the color space converter requires only five multiplication operations that involve relatively simple hardware, the operating efficiency of the color space converter is relatively poor since the multiplication operations are done in two operating stages.

Equations (2) and (3) can be expanded so that the Cb and Cr color signals are entirely in terms of the R, G and B color signals:

Cb=−0.169R−0.331G+0.5B (4)

Cr=0.5R−0.419G−0.081B (5)

Implementation of equations (1), (4) and (5) requires nine multiplication operations, which makes the color space conversion still a relatively expensive computational process.

Therefore, a need exists in the art for a more cost effective method for performing color space conversion between the RGB color space and the YCbCr color space that allows an operation such as hue and saturation control to be performed in a more efficient manner.

### SUMMARY OF THE INVENTION

An objective of various embodiments of the invention is to provide a means for performing hue and saturation modifications without the expense of standard color space converters.

Various embodiments of the present invention are generally directed to a graphics processing apparatus, which includes an RGB color space to a luminance color, blue color difference and red color difference (YCbCr) color space converter module configured to convert one or more pixel data from the RGB color space to the YCbCr color space using a set of approximated color space coefficients. The graphics processing apparatus further includes a hue and saturation control module coupled to the RGB to YCbCr color space converter module. The hue and saturation control module is configured to modify the hue and saturation of the pixel data in the YCbCr color space. The graphics processing apparatus further includes a YCbCr to RGB color space converter module configured to convert the pixel data from the YCbCr color space to the RGB color space.

In one embodiment, the hue and saturation control module determines a modified blue color difference component (Cb′) of the pixel data by multiplying a saturation modification factor with the red color difference component (Cr) of the pixel data and a sine of an angle representing a change in hue and subtracting the result from the blue color difference component (Cb) of the pixel data multiplied by the saturation modification factor and the cosine of the angle representing the change in hue.

In another embodiment, the hue and saturation control module further determines a modified red color difference component (Cr′) of the pixel data by multiplying the red color difference component (Cr) of the pixel data with the saturation modification factor and the cosine of the angle representing the change in hue and adding the result to the blue color difference component (Cb) of the pixel data multiplied by the saturation modification factor and the sine of the angle representing a change in hue.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a simplified block diagram of a computer system according to an embodiment of the present invention.

FIG. 2 is a flow diagram of a method for converting pixel data from an RGB space to a YCbCr space in accordance with one embodiment of the invention.

FIG. 3A illustrates a logic diagram for determining the luminance color component (Y) of the pixel data in accordance with one embodiment of the invention.

FIG. 3B illustrates a logic diagram for determining the blue color difference component (Cb) of the pixel data in accordance with one embodiment of the invention.

FIG. 3C illustrates a logic diagram for determining the red color difference component (Cr) of the pixel data in accordance with one embodiment of the invention.

FIG. 4A illustrates a flow diagram of a method for modifying the hue and saturation of the pixel data in the YCbCr space in accordance with one embodiment of the invention.

FIG. 4B illustrates a color difference plane with color difference vector V₁ and color difference vector V₂.

FIG. 5 illustrates a flow diagram of a method for converting pixel data from the YCbCr space to the RGB space in accordance with one embodiment of the invention.

FIG. 6A illustrates a logic diagram for determining the red color component (R) of the pixel data in accordance with one embodiment of the invention.

FIG. 6B illustrates a logic diagram for determining the green color component (G) of the pixel data in accordance with one embodiment of the invention.

FIG. 6C illustrates a logic diagram for determining the blue color component (B) of the pixel data in accordance with one embodiment of the invention.

### DETAILED DESCRIPTION

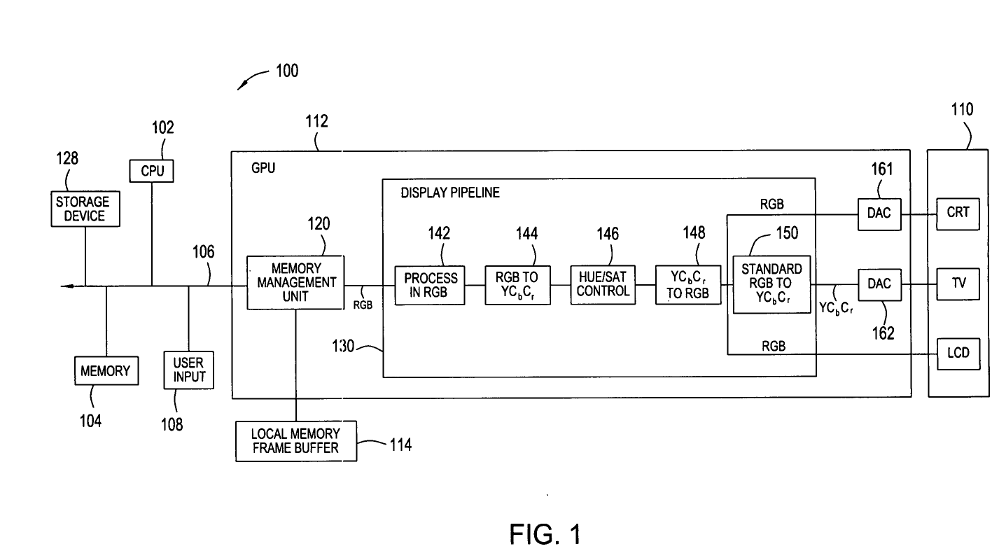

FIG. 1 illustrates a simplified block diagram of a computer system 100 according to an embodiment of the present invention. The computer system 100 includes a central processing unit (CPU) 102 and a system (main) memory 104 communicating via a system bus 106. User input is received from one or more user input devices 108 (e.g., keyboard, mouse) coupled to the system bus 106. Visual output is provided on a pixel based display device 110 (e.g., a conventional CRT, TV or LCD based monitor, projector, etc.) operating under control of a graphics processing unit (GPU) 112 coupled to the bus 106. Other components, such as one or more storage devices 128 (e.g., a fixed or removable magnetic disk drive, compact disk (CD) drive, and/or DVD drive), may also be coupled to the system bus 106. In one embodiment, the computer system 100 operates in a red, green and blue (RGB) color space. Although various embodiments of the invention are described herein with reference to the computer system 100 operating in the RGB color space, the invention contemplates the computer system 100 operating in other color spaces, such as YCbCr.

The system memory 104 stores various programs or applications, such as operating system programs for generating the pixel data to be processed by the GPU 112. Examples of operating system programs 130 include Graphical Device Interface (GDI) component of the Microsoft Windows operating system. The system memory 104 may further store a graphics driver program for enabling communication with the GPU 112. The graphics driver program may implement one or more standard application program interfaces (APIs), such as Open GL and Microsoft DirectX, for communication with the GPU 112. By invoking appropriate API function calls, the operating system programs are able to instruct the graphics driver program to transfer the pixel data to the GPU 112 via the system bus 106 and invoke various rendering functions of the GPU 112. Such pixel data are typically stored and represented in binary form. Data transfer operations may be performed using conventional DMA (direct memory access) or other operations. In one embodiment, the system memory 104 may store pixel data in the RGB color space.

The computer system 100 further includes a local memory or frame buffer 114 in communication with the GPU 112. The frame buffer 114 stores the pixel data to be read by a scanout control logic and transmitted to the display device 110 for display as an image. In one embodiment, the frame buffer 114 stores the pixel data in the RGB color space. Although the frame buffer 114 is shown as distinct and apart from the system memory 104, in some implementations, such as in a Unified Memory Architecture, the frame buffer 114 and the system memory 104 would share the same physical memory devices.

The GPU 112 includes various components for receiving and processing graphics system commands received via the bus 106. The GPU 112 includes a memory management unit 120 and a display pipeline 130. The memory management unit 120 reads the pixel data from the frame buffer 114 or the memory 104, places the pixel data in order and transmits the pixel data to the display pipeline 130 for processing.

The display pipeline 130 is generally used for image processing. The display pipeline 130 may contain various processing modules configured to convert the pixel data into pixel data suitable for displaying on the display device. In an embodiment in which the computer system 100 operates in the RGB color space, the display pipeline 130 may include a module 142 that processes the pixel data in the red green blue (RGB) color space. Examples of processing modules that operate in the RGB color space include brightness control, contrast control and gamma correction.

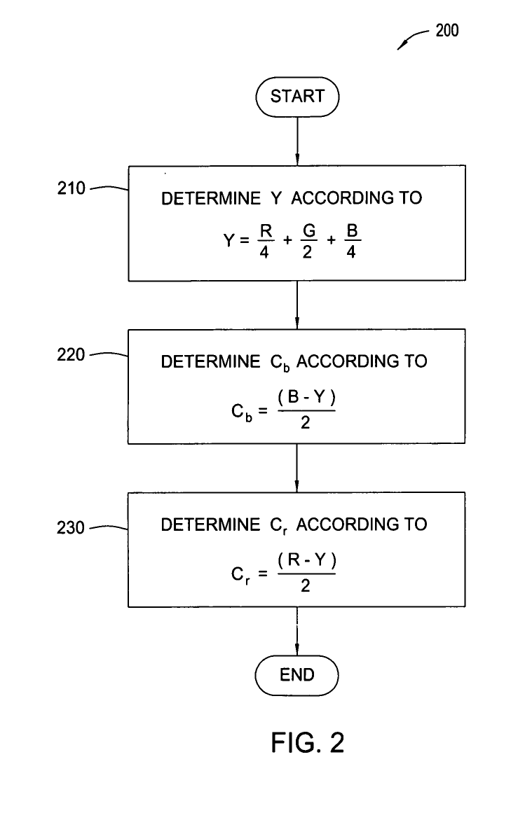

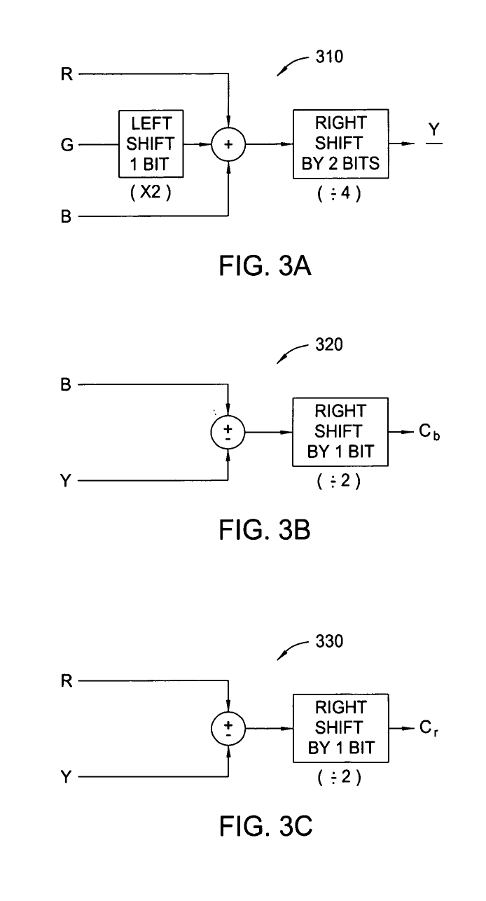

In one embodiment, the display pipeline 130 further includes an RGB to YCbCr color space converter module 144, which is configured to convert the pixel data from the RGB color space to the YCbCr space. A detailed description of the operations of the RGB to YCbCr color space converter module 144 is provided in the paragraphs below with reference to FIGS. 2-3.

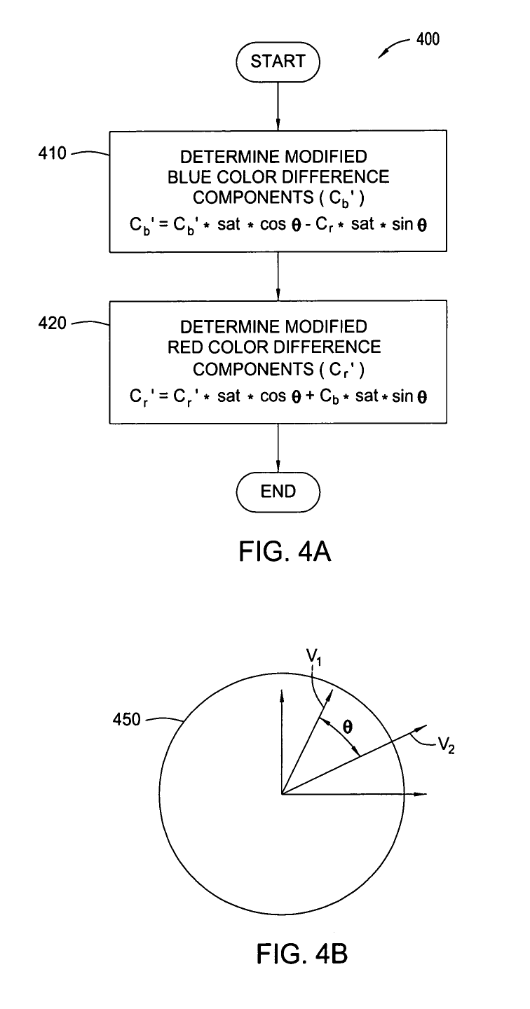

Once the pixel data has been converted to the YCbCr color space, the pixel data may be processed in the YCbCr color space. Accordingly, the display pipeline 130 may further include a hue and saturation control module 146 for modifying the hue or saturation of color of the pixel data in the YCbCr color space. The hue and saturation control module 146 will be described in more detail in the paragraphs below with reference to FIG. 4. The display pipeline 130 may also include other processing modules that operate in the YCbCr color space, such as a horizontal scaler or a vertical scaler.

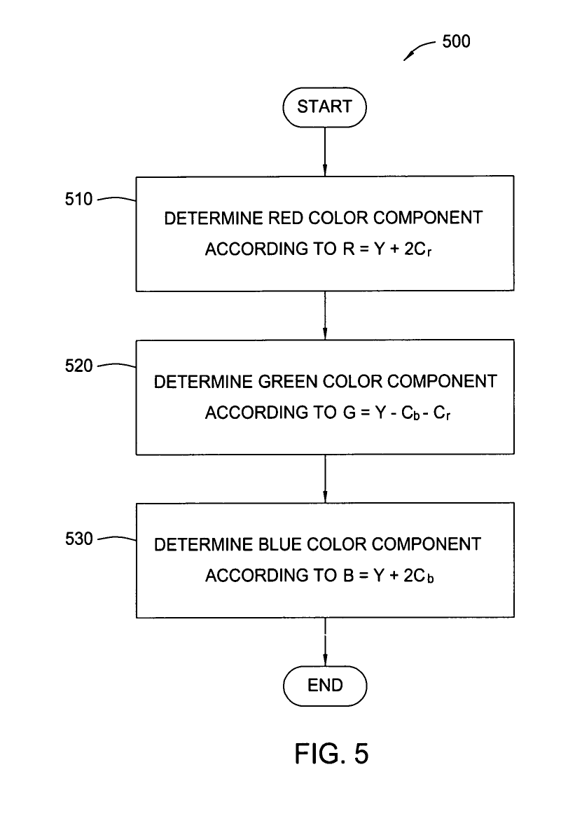

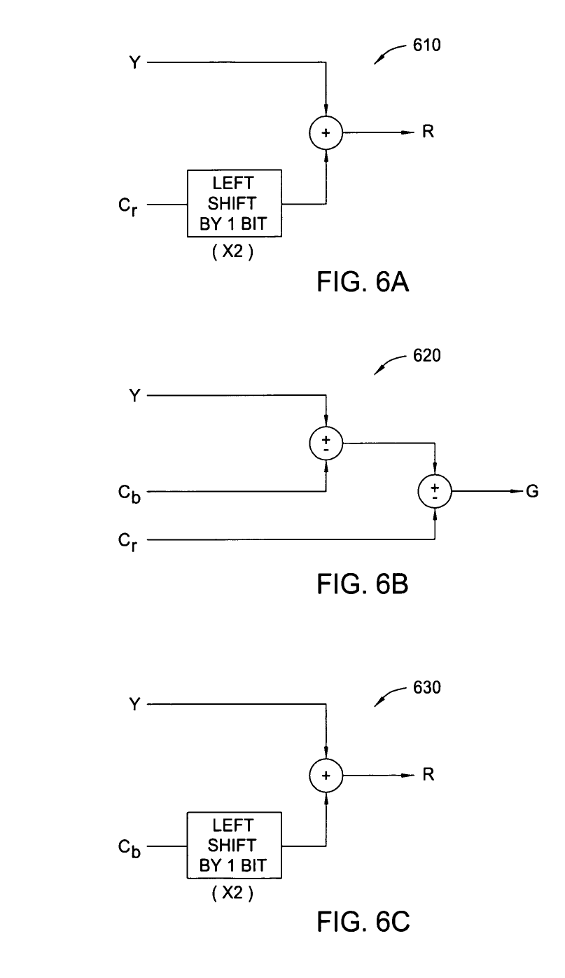

In accordance with one embodiment of the invention, the display pipeline 130 further includes a YCbCr to RGB color space converter module 148, which is configured to convert the pixel data from the YCbCr space to the RGB space. In this manner, the pixel data may be converted back to the RGB space once the processing of the pixel data in the YCbCr space is completed. In one embodiment, the YCbCr to RGB color space converter module 148 converts the pixel data to the RGB space once the hue and saturation of the pixel data has been adjusted by the hue and saturation control module 146. A detailed description of the operations of the YCbCr to RGB color space converter module 148 is provided in the paragraphs below with reference to FIGS. 5-6.

Although the display pipeline 130 has been described with reference to include one RGB to YCbCr color space converter module 144 followed by one YCbCr to RGB color space converter module 148, various embodiments of the invention may contemplate the display pipeline 130 having one YCbCr to RGB color space converter module 148 followed by one RGB to YCbCr color space converter module 144 in a computer system that operates in the YCbCr color space. Various embodiments of the invention may also contemplate the display pipeline 130 having any number of RGB to YCbCr color space converter modules 144 and any number of YCbCr to RGB color space converter modules 148.

In an embodiment in which the pixel data is displayed on a television screen, the display pipeline 130 further includes an industry standard RGB to YCbCr color space converter module 150 to convert the pixel data to the YCbCr space. The industry standard RGB to YCbCr color space converter module 150 operates in connection with a digital to analog converter (DAC) 162 to display the pixel data on the television screen.

In an embodiment in which the pixel data is displayed on a CRT, the display pipeline 130 further includes a digital to analog converter (DAC) 161 to convert the pixel data from digital to analog prior to being displayed on the CRT.

It will be appreciated that the computer system 100 is illustrative and that variations and modifications are possible. The computer system 100 may be a desktop computer, server, laptop computer, palm-sized computer, tablet computer, game console, set-top box, personal digital appliance, tethered Internet appliance, portable gaming system, cellular/mobile telephone, computer based simulator, or the like. The display device 110 can be any pixel-based display, e.g., a CRT or LCD monitor, projector, printer, etc. In some instances, multiple display devices (e.g., an array of projectors or CRT monitors) may be supported, with each device displaying a portion of the image data. The GPU 112 or any of its components may be implemented using one or more programmable processors programmed with appropriate software, application specific integrated circuits (ASICs), other integrated circuit technologies, or any combination of these. In view of the present disclosure, persons of ordinary skill in the art will recognize that the present invention can be embodied in a wide variety of system configurations.

FIG. 2 is a flow diagram of a method 200 for converting pixel data from an RGB space to a YCbCr space in accordance with one embodiment of the invention. At step 210, a luminance color component (Y) of the pixel data is determined using the equation:

Y=R/4+G/2+B/4, (6)

where R is the red color component of the pixel data, G is the green color component of the pixel data, and B is the blue color component of the pixel data. The color space coefficient for the red color component is ¼ or 0.25, which is an approximation of 0.299, the color space coefficient for the red color component according to the industry standard color space converter. The color space coefficient for the green color component is ½ or 0.5, which is also an approximation of 0.587, the color space coefficient for the green color component according to the industry standard color space converter. The color space coefficient for the blue color component is ¼ or 0.25, which is also an approximation of 0.114, the color space coefficient for the blue color component according to the industry standard color space converter. Accordingly, the selected color space coefficients used to calculate the luminance color component (Y) according to equation (6) are in binary form. Since the color space coefficients are in binary form, the luminance color component (Y) may be calculated using binary arithmetic and avoid the use of multiplication. In this manner, the luminance color component (Y) of the pixel data may be determined in a more relatively inexpensive manner.

In accordance with one embodiment of the invention, the luminance color component (Y) of the pixel data may be determined according to a logic diagram 310 illustrated in FIG. 3A. As such, the luminance color component (Y) of the pixel data is determined by left shifting the green color component by one bit (which is equivalent to a multiplication by two), adding the result to the red color component and the blue color component, and right shifting the entire sum by two bits (which is equivalent to a division by four). In one embodiment, the logical diagram 310 may be refined by performing a numerical rounding operation prior to right shifting the entire sum by two bits. Numerical rounding is typically used to improve the accuracy of a result and prevents cumulative errors. The numerical rounding may be performed using conventional techniques, such as adding a value equal to 2 raised to the power of the number of shifted bits minus 1 (i.e., 2^{(s-1)}, where s is the number of shifts) to the entire sum prior to right shifting the entire sum. Left shifting and right shifting operations are free to implement from a cost and computational resource perspectives. Accordingly, the luminance color component (Y) of the pixel data may be determined in a relatively inexpensive manner using the left and right shifting operations described in logic diagram 310.

At step 220, a blue color difference component (Cb) of the pixel data is determined using the equation:

Cb=(B−Y)/2, (7)

where B is the blue color component of the pixel data and Y is the luminance color component (Y) of the pixel data determined at step 210. Like the color coefficients used in equation (6), the color space coefficients used to determine the blue color difference component (Cb) in equation (7) are an approximation of the color space coefficients used to determine the blue color difference component (Cb) according to the industry standard color space converter. In this manner, the color space coefficients used to determine the blue color difference component (Cb) according to equation (7) may be put in binary form. Since the color space coefficients are in binary form, the blue color difference component (Cb) of the pixel data may be calculated using binary arithmetic and avoid the use of multiplication. In this manner, the blue color difference component (Cb) of the pixel data may be determined in a more relatively inexpensive manner.

In accordance with one embodiment of the invention, the blue color difference component (Cb) of the pixel data may be determined according to a logic diagram 320 illustrated in FIG. 3B. As such, the blue color difference component (Cb) of the pixel data is determined by subtracting the luminance color component (Y) of the pixel data determined at step 210 from the blue color component of the pixel data and right shifting the sum by one bit (which is equivalent to a division by two). In one embodiment, a numerical rounding operation may be performed prior to right shifting the sum by one bit. As mentioned above, since right shifting operations are free to implement, the blue color difference component (Cb) of the pixel data may be determined in a relatively inexpensive manner using the right shifting operation described in logic diagram 320.

At step 230, a red color difference component (Cr) of the pixel data is determined using the equation:

Cr=(R−Y)/2, (8)

where R is the red color component of the pixel data and Y is the luminance color component of the pixel data determined at step 210. As in steps 210 and 220, the color space coefficients used to determine the red color difference component (Cr) according to equation (8) are also an approximation of the industry standard color coefficients so that they may be put in binary form. Since the color coefficients are in binary form, the red color difference component (Cr) of the pixel data may be calculated using binary arithmetic and avoid the use of multiplication. In this manner, the red color difference component (Cr) of the pixel data may be determined in a more relatively inexpensive manner.

In accordance with one embodiment of the invention, the red color difference component (Cr) of the pixel data may be determined according to a logic diagram 330 illustrated in FIG. 3C. Referring to FIG. 3C, the red color difference component (Cr) of the pixel data is determined by subtracting the luminance color component (Y) of the pixel data from the red color component of the pixel data and right shifting the result by one bit (which is equivalent to a division by two). In one embodiment, a numerical rounding operation may be performed prior to right shifting the result by one bit. As mentioned above, since right shifting operations are free to implement, the red color difference component (Cr) of the pixel data may be determined in a relatively inexpensive manner using the right shifting operation described in logic diagram 330.

FIG. 4A is a flow diagram of a method 400 for representing modification of the hue and saturation of the pixel data in the YCbCr space in accordance with one embodiment of the invention. The hue of a color may be changed by rotating a color difference vector around the origin of a color difference plane. The saturation of a color may be changed by altering the length of the color difference vector. FIG. 4B illustrates a color difference plane 450 with color difference vector V₁ and color difference vector V₂. The change in hue is represented by θ. The change in saturation is determined by the change in length between color difference vector V₁ and color difference vector V₂.

At step 410, a modified blue color difference component of the pixel data is determined using the equation Cb′=Cb*sat*cos(θ)−Cr*sat*sin(θ), where Cb′ represents the modified blue color difference component of the pixel data, sat represents the saturation modification factor, and θ represents the angle that represents the change in hue. At step 420, a modified red color difference component of the pixel data is determined using the equation Cr′=Cr*sat*cos(θ)+Cb*sat*sin(θ), where Cr′ represents the modified red color difference component of the pixel data, sat represents the saturation modification factor, and θ represents the angle that represents the change in hue. The process described in method 400 may be repeated for each pixel. In addition to the method described above, various embodiments of the invention also contemplate other methods for modifying the hue and saturation of the pixel data in the YCbCr space.

Once the hue and saturation of the pixel data has been modified according to method 400, the pixel data may be converted from the YCbCr space to the RGB space. To that end, FIG. 5 illustrates a flow diagram of a method 500 for converting pixel data from the YCbCr space to the RGB space in accordance with one embodiment of the invention. At step 510, a red color component (R) of the pixel data is determined using the equation:

R=Y+2Cr, (9)

where Y is the luminance color component of the pixel data and Cr is the red color difference component of the pixel data. As in the steps described with reference to FIG. 2, the color space coefficients used to determine the red color component (R) according to equation (9) are also an approximation of the industry standard color coefficients so that they may be put in a binary form. Since the color coefficients are in a binary form, the red color component (R) of the pixel data may be calculated using binary arithmetic and avoid the use of multiplication. In this manner, the red color component (R) of the pixel data to be determined in a more relatively inexpensive manner.

In accordance with one embodiment of the invention, the red color component (R) of the pixel data may be determined according to a logic diagram 610 illustrated in FIG. 6A. Referring now to FIG. 6A, the red color component (R) of the pixel data is determined by left shifting the red color difference component (Cr) of the pixel data by one bit (which is equivalent to a multiplication by two) and adding the result to the luminance color component (Y) of the pixel data. As mentioned above, since left shifting operations are free to implement, the red color component (R) of the pixel data may be determined in a relatively inexpensive manner using the left shifting operation described in logic diagram 610.

At step 520, a green color component (G) of the pixel data is determined using the equation:

G=Y−Cb−Cr, (10)

where Y is the luminance color component of the pixel data, Cb is the blue color difference component of the pixel data and Cr is the red color difference component of the pixel data. As in step 510, the color space coefficients used to determine the green color component (G) according to equation (10) are also an approximation of the industry standard color coefficients so that they may be put in a binary form. Since the color coefficients are in a binary form, the green color component (G) of the pixel data may be calculated using binary arithmetic and avoid the use of multiplication. In this manner, the green color component (G) of the pixel data to be determined in a relatively inexpensive manner.

In accordance with one embodiment of the invention, the green color component (G) of the pixel data may be determined according to a logic diagram 620 illustrated in FIG. 6B. Referring now to FIG. 6B, the green color component (G) of the pixel data is determined by subtracting the blue color difference component (Cb) of the pixel data from the luminance color component Y of the pixel data and further subtracting the red color difference component Cr from the result.

At step 530, a blue color component (B) of the pixel data is determined using the equation:

B=Y+2Cb, (11)

where Y is the luminance color component of the pixel data and Cb is the blue color difference component of the pixel data. As in steps 510 and 520, the color space coefficients used to determine the blue color component (B) according to equation (11) are also in a binary form. Accordingly, the blue color component (B) of the pixel data may be calculated using binary arithmetic and avoid the use of multiplication, which allows the blue color component (B) of the pixel data to be determined in a relatively inexpensive manner.

In accordance with one embodiment of the invention, the blue color component (B) of the pixel data may be determined according to a logic diagram 630 illustrated in FIG. 6C. Referring now to FIG. 6C, the blue color component (B) of the pixel data is determined by left shifting the blue color difference component Cr of the pixel data by one bit (which is equivalent to a multiplication by two) and adding the result to the luminance color component Y of the pixel data. As mentioned above, since left shifting operations are free to implement, the blue color component (B) of the pixel data may be determined in a relatively inexpensive manner using the left shifting operation described in logic diagram 630.

While the foregoing is directed to embodiments of the present invention, other and further embodiments of the invention may be devised without departing from the basic scope thereof, and the scope thereof is determined by the claims that follow.

1. A graphics processing apparatus, comprising:
a digital RGB color space to a luminance color, blue color difference and red color difference (YCbCr) color space converter module that is configured to convert one or more digital pixel data from the RGB color space to the YCbCr color space using a set of approximated color space coefficients to:
determine a blue color difference component (Cb) of the one or more digital pixel data by subtracting a luminance color component (Y) of the one or more digital pixel data from a blue color (B) component of the one or more digital pixel data to generate a first difference, performing a numerical rounding operation on the first difference to generate a first rounded difference, and then right shifting the first rounded difference by one bit, and
determine a red color difference component (Cr) of the one or more digital pixel data by subtracting the luminance color component (Y) of the one or more digital pixel data from a red color (R) component of the one or more digital pixel data to generate a second difference, performing a numerical rounding operation on the second difference to generate a second rounded difference, and then right shifting the second rounded difference by one bit;
a digital hue and saturation control module coupled to the digital RGB to YCbCr color space converter module, wherein the digital hue and saturation control module is configured to modify the hue and saturation of the digital pixel data in the YCbCr color space; and
a digital YCbCr to RGB color space converter module configured to convert the one or more digital pixel data from the YCbCr color space to the RGB color space.

2. The graphics processing apparatus of claim 1, wherein the digital hue and saturation control module determines a modified blue color difference component (Cb′) of the one or more digital pixel data by:
multiplying a saturation modification factor with the red color difference component (Cr) of the one or more digital pixel data and a sine of an angle representing a change in hue; and
subtracting the result from the blue color difference component (Cb) of the one or more digital pixel data multiplied by the saturation modification factor and the cosine of the angle representing the change in hue.

3. The graphics processing apparatus of claim 2, wherein the digital hue and saturation control module further determines a modified red color difference component (Cr′) of the one or more digital pixel data by:
multiplying the red color difference component (Cr) of the one or more digital pixel data with the saturation modification factor and the cosine of the angle representing the change in hue; and
adding the result to the blue color difference component (Cb) of the one or more digital pixel data multiplied by the saturation modification factor and the sine of the angle representing a change in hue.

4. The graphics processing apparatus of claim 1, wherein the digital hue and saturation control module further determines a modified red color difference component (Cr′) of the one or more digital pixel data by:
multiplying the red color difference component (Cr) of the one or more digital pixel data with a saturation modification factor and the cosine of an angle representing a change in hue; and
adding the result to the blue color difference component (Cb) of the one or more digital pixel data multiplied by the saturation modification factor and the sine of the angle representing a change in hue.

5. The graphics processing apparatus of claim 1, wherein the digital RGB to YCbCr color space converter module determines a luminance color component (Y) of the one or more digital pixel data by left shifting the green color (G) component of the one or more digital pixel data by one bit; adding the result to the red color (R) component of the one or more digital pixel data and the blue color (B) component of the one or more digital pixel data to generate a first sum; performing a numerical rounding operation on the first sum to generate a first rounded sum, and right shifting the first rounded sum by two bits.

6-7. (canceled)

8. The graphics processing apparatus of claim 1, wherein the digital YCbCr to RGB color space converter module determines the red color (R) component of the one or more pixel data by left shifting the red color difference component (Cr) of the one or more pixel data by one bit; and adding the result to the luminance color component (Y) of the one or more pixel data.

9. The graphics processing apparatus of claim 0, wherein the digital YCbCr to RGB color space converter module further determines the green color (G) component of the one or more pixel data by subtracting the red color difference component (Cr) and the blue color difference component (Cb) of the one or more pixel data from the luminance color component (Y) of the one or more pixel data.

10. The graphics processing apparatus of claim 9, wherein the digital YCbCr to RGB color space converter module further determines the blue color (B) component of the one or more digital pixel data by left shifting the blue color difference (Cb) component of the one or more digital pixel data by one bit; and adding the result to the luminance color component (Y) of the one or more digital pixel data.

11. A method for modifying a hue and saturation of one or more digital pixel data, comprising:
receiving the one or more digital pixel data in a red, blue and green (RGB) color space;
converting the one or more digital pixel data from the RGB color space to a luminance, blue color difference and red color difference (YCbCr) color space using a set of approximated color space coefficients, to:
determine a blue color difference component (Cb) of the one or more digital pixel data by subtracting a luminance color component (Y) of the one or more digital pixel data from a blue color (B) component of the one or more digital pixel data to generate a first difference, performing a numerical rounding operation on the first difference to generate a first rounded difference, and then right shifting the first rounded difference by one bit, and
determine a red color difference component (Cr) of the one or more digital pixel data by subtracting the luminance color component (Y) of the one or more digital pixel data from a red color (R) component of the one or more digital pixel data to generate a second difference, performing a numerical rounding operation on the second difference to generate a second rounded difference, and then right shifting the second rounded difference by one bit; and
modifying the hue and saturation of the pixel data in the YCbCr space.

12. The method of claim 9, wherein modifying the hue and saturation of the one or more digital pixel data comprises determining a modified blue color difference component (Cb′) of the one or more digital pixel data by:
multiplying a saturation modification factor with the red color difference component (Cr) of the one or more digital pixel data and a sine of an angle representing a change in hue; and
subtracting the result from the blue color difference component (Cb) of the one or more digital pixel data multiplied by the saturation modification factor and the cosine of the angle representing the change in hue.

13. The method of claim 10, modifying the hue and saturation of the one or more digital pixel data comprises determining a modified red color difference component (Cr′) of the one or more digital pixel data by:
multiplying the red color difference component (Cr) of the one or more digital pixel data with a saturation modification factor and the cosine of an angle representing a change in hue; and
adding the result to the blue color difference component (Cb) of the one or more digital pixel data multiplied by the saturation modification factor and the sine of the angle representing the change in hue.

14. The method of claim 9, modifying the hue and saturation of the one or more digital pixel data comprises determining a modified red color difference component (Cr′) of the one or more digital pixel data by:
multiplying the red color difference component (Cr) of the one or more digital pixel data with a saturation modification factor and the cosine of an angle representing a change in hue; and
adding the result to the blue color difference component (Cb) of the one or more digital pixel data multiplied by the saturation modification factor and the sine of the angle representing the change in hue.

15. The method of claim 9, wherein converting the one or more digital pixel data from the RGB color space to the YCbCr color space comprises determining a luminance color component (Y) by adding ¼ of a red color (R) component of the one or more digital pixel data to ½ of a green color (G) component of the one or more digital pixel data and 1/4 of a blue color (B) component of the one or more digital pixel data.

16-17. (canceled)

18. The method of claim 9, further comprising converting the one or more digital pixel data from the YCbCr color space to the RGB color space by adding the luminance color component (Y) of the one or more digital pixel data to twice the red color difference component (Cr) of the one or more digital pixel data to generate the red color (R) component of the one or more digital pixel data, generating the green color (G) component of the one or more digital pixel data and generating the blue color (B) component of the one or more digital pixel data.

19. The method of claim 16, wherein generating the green color (G) component of the one or more digital pixel data comprises subtracting the red color difference component (Cr) of the one or more digital pixel data and the blue color difference component (Cb) of the one or more digital pixel data from the luminance color component (Y) of the one or more digital pixel data.

20. The method of claim 17, wherein generating the blue color (B) component of the one or more digital pixel data comprises adding the luminance color component (Y) of the one or more digital pixel data to twice the blue color difference component (Cb) of the one or more digital pixel data.

21. The graphics processing apparatus of claim 1, wherein the digital RGB to YCbCr color space converter module determines a luminance color component (Y) by adding ¼ of a red color (R) component of the one or more digital pixel data to ½ of a green color (G) component of the one or more digital pixel data and ¼ of a blue color (B) component of the one or more digital pixel data.

22. The method of claim 9, wherein converting the one or more digital pixel data from the RGB color space to the YCbCr color space comprises determining a luminance color component (Y) of the one or more digital pixel data by left shifting the green color (G) component of the one or more digital pixel data by one bit; adding the result to the red color (R) component of the one or more digital pixel data and the blue color (B) component of the one or more digital pixel data to generate a first sum; and performing a rounding operation on the first sum to generate a first rounded sum, and right shifting the sum by two bits.
